(19) United States
(12) Patent Application Publication
(10) Pub. No.: US 2003/0127240 A1
(43) Pub. Date: Jul. 10, 2003

(54) Housing for an electrical device

(76) Inventors: Kai Beckbissinger, Stuttgart (DE); Guenter Eisermann, Karlsfeld (DE); Rainer Kalass, Rohr (DE); Ewald Simon, Lauf (DE)

Correspondence Address: Striker Striker & Stenby, 103 East Neck Road, Huntington, NY, 11743, US

(21) Appl. No.: 10/221,293

(22) PCT Filed: Mar. 13, 2001
(86) PCT No.: PCT/DE01/00935

(30) Foreign Application Priority Data
Mar. 14, 2000 (DE) 100 12 297.3

(51) Int. Cl. H02G 3/08

(52) U.S. Cl. 174/50

(57) ABSTRACT

A housing for an electrical device is proposed that contains electrical or electronic components and that is capable of being submersed in a liquid medium. A pressure-equalization element (2) is present on the housing (1), by means of Which compensation of the pressure inside the housing (1) with the outside pressure can be obtained. The outside pressure is delivered to the pressure-equalization element (2) via a submersible bulb (5) that is also submersed in the liquid medium, and the enclosed air volume of which has an active connection with the outside of the pressure-equalization element (2). The volume of air in the submersible bulb (5) is dimensioned so that it is greater than the volume of air to be tracked given a specified temperature decrease in the housing (1).

### BACKGROUND OF THE INVENTION

The invention concerns a housing for an electrical device according to the general class of the main claim.

Electrical and electronic components, in particular electronic control units in motor vehicles, are typically installed in relatively air-tight housings to protect them from external influences. In particular, such housings must protect the electronic components, the printed-circuit boards and other circuit devices from liquid and, possibly, aggressive media that can penetrate the housing.

It is common in and of itself to outfit such housings with elements for pressure compensation. This allows pressure compensation to take place between the pressure inside the housing and the atmospheric pressure in order to prevent liquid media from penetrating the interior of the housing. To prevent penetration by liquid media at these pressure-equalization elements themselves, it is also standard for them to be closable with a water-tight and breathable film so that the electrical or electronic components are protected against penetration by liquid media.

The disadvantage of these arrangements, however, is the fact that, when a certain pressure differential, or burst pressure, between the inside of the housing and the environment is reached, while, at the same time, a liquid medium bears against the pressure-equalization element, this medium can penetrate the pressure-equalization element, which can result in damage to the electrical or electronic components. Furthermore, the vacuum occurring inside the housing can also result in liquid media penetrating the interior of the housing if micro-leaks exist in the housing parts and sealing sites.

### ADVANTAGES OF THE INVENTION

A housing for an electrical device of the type mentioned initially, in which the housing contains electrical or electronic components and that is capable of being submersed in a liquid medium is advantageously developed further with the other features of the main claim. A pressure-equalization element is present on the housing, with which compensation of the pressure inside the housing with the outside pressure can be obtained and the outside pressure is delivered to the pressure-equalization element. This takes place in advantageous fashion via a submersible bulb that is also submersed in the liquid medium and the enclosed air volume of which has an active connection with the outside of the pressure-equalization element.

It is therefore possible that, in the case of a housing of the type mentioned hereinabove, pressure compensation is made possible on the one hand and, on the other, the electrical or electronic components are simultaneously protected reliably against penetration by liquid media and they can therefore not be flooded. The basic idea hereby is that liquid media are prevented from being located next to the pressure-equalization element at all when pressure differentials exist between the inside of the housing and the environment.

According to the invention, the volume of air in the submersible bulb is dimensioned such that it is greater than the air volume to be tracked given a specified temperature decrease in the housing. In the case of a preferred exemplary embodiment, the submersible bulb is connected flexibly in simple fashion via a hose connection to a connection adapter located on the pressure-equalization element, whereby, in particularly advantageous fashion, the hose connection is held in rotatable fashion, sealed via a ring seal.

Furthermore, the connection adapter can be held at the housing in simple fashion via a further seal and by means of fastening elements while enclosing the pressure-equalization element. Additionally, the atmospheric pressure can be detected electronically here inside the housing, and the measurement variable can be made available to the engine management when used in a motor vehicle, for example.

These and further features of preferred further developments of the invention arise from the claims as well as from the description and the drawings, whereby the individual features can be realized separately in each case or in plurality in the form of subcombinations in the case of the exemplary embodiment of the invention and in other fields, and they can represent advantageous and, strictly speaking, patentable embodiments for which protection is claimed here.

### SUMMARY OF THE DRAWINGS

An exemplary embodiment of the housing according to the invention for an electrical device is explained with reference to the drawings.

FIG. 1 shows a view of a housing for an electronic control unit capable of being submersed in a liquid medium having a pressure-equalization element and a submersible bulb connected to it, and

FIG. 2 shows a detained view of the pressure-equalization element according to FIG. 1.

### DESCRIPTION OF THE PREFERRED EMBODIMENTS

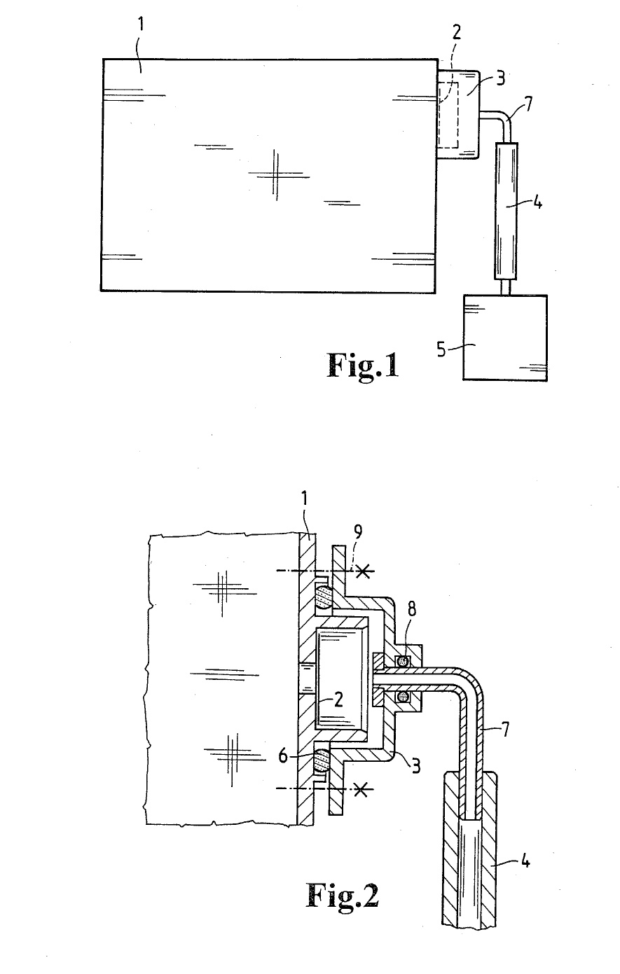

A housing 1 for an electronic control unit outfitted with a pressure-equalization element 2 is shown in FIG. 1. A connection adapter 3 for a hose connection 4 with a submersible bulb 5 is located on the pressure-equalization element 2.

The pressure-equalization element 2 is shown in detail in the illustration according to FIG. 2 as well. It is further obvious here that the connection adapter 3 abuts the housing 1 via a seal 6, and the hose connection 4 with a hose connector 7 is held at the connection adapter 3 in rotatable fashion via a sealing ring 8. The connection adapter 3 is secured at the housing 1 by means of one or more screw connections 9.

The submersible bulb 5 visible in FIG. 1 in particular is therefore adapted at the pressure-equalization element 2 in air-tight fashion via the hose connection 4. By means of suitable dimensions, the volume of air enclosed in the submersible bulb 5 is selected greater here than the volume of air located inside the housing 1 that must be tracked when the housing 1 cools down, in order to compensate the pressure differential between the inside of the housing and the environment.

When this cooling-down takes place by submersion of the housing 1 in a liquid medium, e.g., when used as an electronic control unit in a motor vehicle, the submersible bulb 5 prevents the liquid medium from being located directly next to the pressure-equalization element 2. This ensures pressure compensation between the inside of the housing 1 and the environment, and prevents penetration by the liquid medium.

What is claimed is:

1. A housing for an electrical device,
that contains electrical or electronic components and that is capable of being submersed in a liquid medium, whereby
a pressure-equalization element (2) is present on the housing (1) by means of which compensation of the pressure inside the housing (1) with the outside pressure can be obtained, and
the delivery of the outside pressure to the pressure-equalization element (2) takes place via a submersible bulb (5) that is also submersed in the liquid medium, and the enclosed air volume of which has an active connection with the outside of the pressure-equalization element (2).

2. The housing according to claim 1, wherein
the volume of air in the submersible bulb (5) is dimensioned so that it is greater than the volume of air to be tracked given a specified temperature decrease in the housing (1).

3. The housing according to claim 1 or 2, wherein
the submersible bulb (5) is connected flexibly via a hose connection (4) to a connection adapter (3) located on the pressure-equalization element (2).

4. The housing according to claim 3, wherein
the hose connection (4) with a hose connector (7) is held in rotatable fashion, sealed via a sealing ring (8).

5. The housing according to claim 3 or 4, wherein
the connection adapter (3) is held at the housing (1) via a seal (6) and by means of one or more fastening elements (9) while enclosing the pressure-equalization element (2).
